(19) United States
(12) Patent Application Publication
(10) Pub. No.: US 2023/0410049 A1
(43) Pub. Date: Dec. 21, 2023

(54) System, Method, and Computer Program Product for Generating and Executing a Workflow Program

(71) Applicant: Orbitax LLC, Palo Alto, CA (US)

(72) Inventor: Gratian Joseph, Pacifica, CA (US)

(21) Appl. No.: 18/209,654

(22) Filed: Jun. 14, 2023

Related U.S. Application Data
(60) Provisional application No. 63/352,702, filed on Jun. 16, 2022.

(51) Int. Cl. G06Q 10/10; G06Q 10/0633; G06Q 40/12

(52) U.S. Cl. CPC G06Q 10/103; G06Q 10/0633; G06Q 40/123

(57) ABSTRACT

Provided is a system, method, and apparatus for generating and executing a workflow program. The method includes providing an interactive graphical user interface configured to facilitate each advisor user to create at least one workflow program, receive a plurality of workflow programs, each workflow program including at least a portion of an executable workflow, receive workflow data associated with the plurality of workflow programs, the workflow data including at least one element of metadata, host the plurality of workflow programs in association with the workflow data, receive, from a client user of the plurality of client users, a selected workflow program of the plurality of workflow programs, the selected workflow program associated with an advisor user of the plurality of advisor users, and generate a workspace environment accessible to the advisor user corresponding to the selected workflow program.

### CROSS REFERENCE TO RELATED APPLICATION

This application claims the benefit of U.S. Provisional Patent Application No. 63/352,702, filed Jun. 16, 2022, the disclosure of which is hereby incorporated by reference in its entirety.

### BACKGROUND

### 1. Field

This disclosure relates generally to workflows for multi-national entities and, in non-limiting embodiments, to systems, methods, and computer program products for generating and executing a workflow program for the preparation of documents.

### 2. Technical Considerations

Multi-national entities (MNEs) (e.g., multi-national organizations) need to comply with multiple national tax laws. The changes in international tax rules make it complex for companies having multiple entities in different countries to track the changes in tax laws, understand which ones have an impact, and coordinate with multiple stakeholders internally to perform appropriate actions. Given the expansiveness and complexity of regulatory requirements for multi-national organizations, existing systems are unable to coordinate contributions from multiple sources and individuals to ensure data entry of timely, complete, and accurate information.

For advisors to work with MNEs or other entities to prepare and file tax documents, they often have to work closely together, sift through volumes of client documentation and data, and undergo activities that the entity may not have any visibility into. This results in inefficiencies, duplicated efforts, and wasted resources.

### SUMMARY

According to non-limiting embodiments or aspects, provided is a method comprising: providing an interactive graphical user interface to a plurality of advisor users, the interactive graphical user interface configured to facilitate each advisor user to create at least one workflow program; receiving, from the plurality of advisor users, a plurality of workflow programs, each workflow program comprising at least a portion of an executable workflow; receiving, from the plurality of advisor users, workflow data associated with the plurality of workflow programs, the workflow data comprising at least one element of metadata; hosting, on a platform accessible to a plurality of client users, the plurality of workflow programs in association with the workflow data; receiving, from a client user of the plurality of client users, a selected workflow program of the plurality of workflow programs, the selected workflow program associated with an advisor user of the plurality of advisor users; generating a workspace environment accessible to the advisor user corresponding to the selected workflow program, the workspace environment based on the at least a portion of the executable workflow associated with the selected workflow program; populating the workspace environment with entity data received from or identified by the client user to configure an executable workflow; and automatically executing the executable workflow in response to at least one of the following: a user request, a scheduled time, a change in law or regulation, a change in entity data, or any combination thereof.

In non-limiting embodiments or aspects, the workspace environment comprises a second interactive graphical user interface configured to visualize the executable workflow and modify the executable workflow based on input received from the advisor user through the second interactive graphical user interface or received from the client user through a prompt. In non-limiting embodiments or aspects, the method further comprises: determining at least one suggested workflow program based at least partially on an entity footprint associated with an entity of the client users; and displaying the at least one suggested workflow program to the client user, the at least one suggested workflow program comprising the selected workflow program. In non-limiting embodiments or aspects, the at least one suggested workflow program is determined based at least partially on a change in law or regulation. In non-limiting embodiments or aspects, the method further comprises: displaying, to the client user, a search interface configured to receive at least one search parameter; querying metadata associated with the plurality of workflow programs based on the at least one search parameter to identify at least one workflow program matching the at least one search parameter; and displaying the at least one workflow program to the client user, the at least one workflow program comprising the selected workflow program. In non-limiting embodiments or aspects, the workflow data comprises metadata including the at least one element of metadata, the metadata comprising at least one of the following: a service agreement, an identification of at least one advisor contract, a description of a workflow program, a form, a role associated with the workflow program, an individual advisor associated with the workflow program, or any combination thereof.

In non-limiting embodiments or aspects, the method further comprises: receiving, from the client user, input data in response to at least one of the following: a questionnaire, a form, a prompt, or any combination thereof; and configuring the executable workflow based at least partially on the input data. In non-limiting embodiments or aspects, the input data comprises the entity data. In non-limiting embodiments or aspects, wherein generating the workspace environment comprises modifying an existing workspace environment to include the selected workflow program. In non-limiting embodiments or aspects, wherein generating the workspace environment comprises generating at least one graphical user interface configured to access data in an existing workspace environment. In non-limiting embodiments or aspects, the method further comprises: receiving, from the client user, a filter identifying a subset of entity data; and retrieving the subset of entity data based on the filter. In non-limiting embodiments or aspects, the method further comprises: receiving, from the advisor user, a filter identifying requested entity data; communicating, to the client user, a data access request based on the filter; and receiving, from the client user, an approval or denial of the data access request. In non-limiting embodiments or aspects, the method further comprises: generating a dashboard graphical user interface accessible by the client user, the dashboard graphical user interface comprising an identification of an advisor and/or an advisor contract associated with the selected workflow program. In non-limiting embodiments or aspects, the selected workflow program comprises at least one node configured to generate a prompt to the client user to request a review of data or a document.

According to non-limiting embodiments or aspects, provided is a system comprising at least one processor programmed or configured to: provide an interactive graphical user interface to a plurality of advisor users, the interactive graphical user interface configured to facilitate each advisor user to create at least one workflow program; receive, from the plurality of advisor users, a plurality of workflow programs, each workflow program comprising at least a portion of an executable workflow; receive, from the plurality of advisor users, workflow data associated with the plurality of workflow programs, the workflow data comprising at least one element of metadata; host, on a platform accessible to a plurality of client users, the plurality of workflow programs in association with the workflow data; receive, from a client user of the plurality of client users, a selected workflow program of the plurality of workflow programs, the selected workflow program associated with an advisor user of the plurality of advisor users; generate a workspace environment accessible to the advisor user corresponding to the selected workflow program, the workspace environment based on the at least a portion of the executable workflow associated with the selected workflow program; populate the workspace environment with entity data received from or identified by the client user to configure an executable workflow; and automatically execute the executable workflow in response to at least one of the following: a user request, a scheduled time, a change in law or regulation, a change in entity data, or any combination thereof.

In non-limiting embodiments or aspects, the workspace environment comprises a second interactive graphical user interface configured to visualize the executable workflow and modify the executable workflow based on input received from the advisor user through the second interactive graphical user interface or received from the client user through a prompt. In non-limiting embodiments or aspects, the at least one processor is further programmed or configured to: determine at least one suggested workflow program based at least partially on an entity footprint associated with an entity of the client user; and display the at least one suggested workflow program to the client user, the at least one suggested workflow program comprising the selected workflow program. In non-limiting embodiments or aspects, the at least one suggested workflow program is determined based at least partially on a change in law or regulation. In non-limiting embodiments or aspects, the at least one processor is further programmed or configured to: display, to the client user, a search interface configured to receive at least one search parameter; querying metadata associated with the plurality of workflow programs based on the at least one search parameter to identify at least one workflow program matching the at least one search parameter; and display the at least one workflow program to the client user, the at least one workflow program comprising the selected workflow program. In non-limiting embodiments or aspects, the workflow data comprises metadata including the at least one element of metadata, the metadata comprising at least one of the following: a service agreement, an identification of at least one advisor contract, a description of a workflow program, a form, a role associated with the workflow program, an individual advisor associated with the workflow program, or any combination thereof.

In non-limiting embodiments or aspects, the at least one processor is further programmed or configured to: receive, from the client, input data in response to at least one of the following: a questionnaire, a form, a prompt, or any combination thereof; and configuring the executable workflow based at least partially on the input data. In non-limiting embodiments or aspects, the input data comprises the entity data. In non-limiting embodiments or aspects, generating the workspace environment comprises modifying an existing workspace environment to include the selected workflow program. In non-limiting embodiments or aspects, generating the workspace environment comprises generate at least one graphical user interface configured to access data in an existing workspace environment. In non-limiting embodiments or aspects, the at least one processor is further programmed or configured to: receive, from the client user, a filter identifying a subset of entity data; and retrieving the subset of entity data based on the filter. In non-limiting embodiments or aspects, the at least one processor is further programmed or configured to: receive, from the advisor user, a filter identifying requested entity data; communicate, to the client user, a data access request based on the filter; and receive, from the client user, an approval or denial of the data access request. In non-limiting embodiments or aspects, the at least one processor is further programmed or configured to: generate a dashboard graphical user interface accessible by the client user, the dashboard graphical user interface comprising an identification of an advisor and/or an advisor contract associated with the selected workflow program. In non-limiting embodiments or aspects, the selected workflow program comprises at least one node configured to generate a prompt to the client user to request a review of data or a document.

According to non-limiting embodiments or aspects, provided is a computer program product comprising at least one non-transitory medium including program instructions that, when executed by at least one processor, cause the at least one processor: provide an interactive graphical user interface to a plurality of advisor users, the interactive graphical user interface configured to facilitate each advisor user to create at least one workflow program; receive, from the plurality of advisor users, a plurality of workflow programs, each workflow program comprising at least a portion of an executable workflow; receive, from the plurality of advisor users, workflow data associated with the plurality of workflow programs, the workflow data comprising at least one element of metadata; host, on a platform accessible to a plurality of client users, the plurality of workflow programs in association with the workflow data; receive, from a client user of the plurality of client users, a selected workflow program of the plurality of workflow programs, the selected workflow program associated with an advisor user of the plurality of advisor users; generate a workspace environment accessible to the advisor user corresponding to the selected workflow program, the workspace environment based on the at least a portion of the executable workflow associated with the selected workflow program; populate the workspace environment with entity data received from or identified by the client user to configure an executable workflow; and automatically execute the executable workflow in response to at least one of the following: a user request, a scheduled time, a change in law or regulation, a change in entity data, or any combination thereof.

In non-limiting embodiments or aspects, the workspace environment comprises a second interactive graphical user interface configured to visualize the executable workflow and modify the executable workflow based on input received from the advisor user through the second interactive graphical user interface or received from the client user through a prompt. In non-limiting embodiments or aspects, the program instructions further cause the at least one processor to: determine at least one suggested workflow program based at least partially on an entity footprint associated with an entity of the client user; and display the at least one suggested workflow program to the client user, the at least one suggested workflow program comprising the selected workflow program. In non-limiting embodiments or aspects, the at least one suggested workflow program is determined based at least partially on a change in law or regulation. In non-limiting embodiments or aspects, the program instructions further cause the at least one processor to: display, to the client user, a search interface configured to receive at least one search parameter; querying metadata associated with the plurality of workflow programs based on the at least one search parameter to identify at least one workflow program matching the at least one search parameter; and display the at least one workflow program to the client user, the at least one workflow program comprising the selected workflow program. In non-limiting embodiments or aspects, the workflow data comprises metadata including the at least one element of metadata, the metadata comprising at least one of the following: a service agreement, an identification of at least one advisor contract, a description of a workflow program, a form, a role associated with the workflow program, an individual advisor associated with the workflow program, or any combination thereof.

In non-limiting embodiments or aspects, the program instructions further cause the at least one processor to: receive, from the client, input data in response to at least one of the following: a questionnaire, a form, a prompt, or any combination thereof; and configuring the executable workflow based at least partially on the input data. In non-limiting embodiments or aspects, the input data comprises the entity data. In non-limiting embodiments or aspects, wherein generate the workspace environment comprises modifying an existing workspace environment to include the selected workflow program. In non-limiting embodiments or aspects, wherein generate the workspace environment comprises generate at least one graphical user interface configured to access data in an existing workspace environment. In non-limiting embodiments or aspects, the program instructions further cause the at least one processor to: receive, from the client user, a filter identifying a subset of entity data; and retrieving the subset of entity data based on the filter. In non-limiting embodiments or aspects, the program instructions further cause the at least one processor to: receive, from the advisor user, a filter identifying requested entity data; communicate, to the client user, a data access request based on the filter; and receive, from the client user, an approval or denial of the data access request. In non-limiting embodiments or aspects, the program instructions further cause the at least one processor to: generate a dashboard graphical user interface accessible by the client user, the dashboard graphical user interface comprising an identification of an advisor and/or an advisor contract associated with the selected workflow program. In non-limiting embodiments or aspects, the selected workflow program comprises at least one node configured to generate a prompt to the client user to request a review of data or a document.

Non-limiting embodiments and aspects are set forth in the following numbered clauses:
Clause 1: A method comprising: providing an interactive graphical user interface to a plurality of advisor users, the interactive graphical user interface configured to facilitate each advisor user to create at least one workflow program; receiving, from the plurality of advisor users, a plurality of workflow programs, each workflow program comprising at least a portion of an executable workflow; receiving, from the plurality of advisor users, workflow data associated with the plurality of workflow programs, the workflow data comprising at least one element of metadata; hosting, on a platform accessible to a plurality of client users, the plurality of workflow programs in association with the workflow data; receiving, from a client user of the plurality of client users, a selected workflow program of the plurality of workflow programs, the selected workflow program associated with an advisor user of the plurality of advisor users; generating a workspace environment accessible to the advisor user corresponding to the selected workflow program, the workspace environment based on the at least a portion of the executable workflow associated with the selected workflow program; populating the workspace environment with entity data received from or identified by the client user to configure an executable workflow; and automatically executing the executable workflow in response to at least one of the following: a user request, a scheduled time, a change in law or regulation, a change in entity data, or any combination thereof.
Clause 2: The method of clause 1, wherein the workspace environment comprises a second interactive graphical user interface configured to visualize the executable workflow and modify the executable workflow based on input received from the advisor user through the second interactive graphical user interface or received from the client user through a prompt.
Clause 3: The method of clauses 1 or 2, further comprising: determining at least one suggested workflow program based at least partially on an entity footprint associated with an entity of the client users; and displaying the at least one suggested workflow program to the client user, the at least one suggested workflow program comprising the selected workflow program.
Clause 4: The method of any of clauses 1-3, wherein the at least one suggested workflow program is determined based at least partially on a change in law or regulation.
Clause 5: The method of any of clauses 1-4, further comprising: displaying, to the client user, a search interface configured to receive at least one search parameter; querying metadata associated with the plurality of workflow programs based on the at least one search parameter to identify at least one workflow program matching the at least one search parameter; and displaying the at least one workflow program to the client user, the at least one workflow program comprising the selected workflow program.
Clause 6: The method of any of clauses 1-5, wherein the workflow data comprises metadata including the at least one element of metadata, the metadata comprising at least one of the following: a service agreement, an identification of at least one advisor contract, a description of a workflow program, a form, a role associated with the workflow program, an individual advisor associated with the workflow program, or any combination thereof.
Clause 7: The method of any of clauses 1-6, further comprising: receiving, from the client user, input data in response to at least one of the following: a questionnaire, a form, a prompt, or any combination thereof; and configuring the executable workflow based at least partially on the input data.
Clause 8: The method of any of clauses 1-7, wherein the input data comprises the entity data.
Clause 9: The method of any of clauses 1-8, wherein generating the workspace environment comprises modifying an existing workspace environment to include the selected workflow program.
Clause 10: The method of any of clauses 1-9, wherein generating the workspace environment comprises generating at least one graphical user interface configured to access data in an existing workspace environment.
Clause 11: The method of any of clauses 1-10, further comprising: receiving, from the client user, a filter identifying a subset of entity data; and retrieving the subset of entity data based on the filter.
Clause 12: The method of any of clauses 1-11, further comprising: receiving, from the advisor user, a filter identifying requested entity data; communicating, to the client user, a data access request based on the filter; and receiving, from the client user, an approval or denial of the data access request.
Clause 13: The method of any of clauses 1-12, further comprising: generating a dashboard graphical user interface accessible by the client user, the dashboard graphical user interface comprising an identification of an advisor and/or an advisor contract associated with the selected workflow program.
Clause 14: The method of any of clauses 1-13, wherein the selected workflow program comprises at least one node configured to generate a prompt to the client user to request a review of data or a document.
Clause 15: A system comprising at least one processor programmed or configured to: provide an interactive graphical user interface to a plurality of advisor users, the interactive graphical user interface configured to facilitate each advisor user to create at least one workflow program; receive, from the plurality of advisor users, a plurality of workflow programs, each workflow program comprising at least a portion of an executable workflow; receive, from the plurality of advisor users, workflow data associated with the plurality of workflow programs, the workflow data comprising at least one element of metadata; host, on a platform accessible to a plurality of client users, the plurality of workflow programs in association with the workflow data; receive, from a client user of the plurality of client users, a selected workflow program of the plurality of workflow programs, the selected workflow program associated with an advisor user of the plurality of advisor users; generate a workspace environment accessible to the advisor user corresponding to the selected workflow program, the workspace environment based on the at least a portion of the executable workflow associated with the selected workflow program; populate the workspace environment with entity data received from or identified by the client user to configure an executable workflow; and automatically execute the executable workflow in response to at least one of the following: a user request, a scheduled time, a change in law or regulation, a change in entity data, or any combination thereof.
Clause 16: The system of clause 15, wherein the workspace environment comprises a second interactive graphical user interface configured to visualize the executable workflow and modify the executable workflow based on input received from the advisor user through the second interactive graphical user interface or received from the client user through a prompt.
Clause 17: The system of clauses 15 or 16, wherein the at least one processor is further programmed or configured to: determine at least one suggested workflow program based at least partially on an entity footprint associated with an entity of the client user; and display the at least one suggested workflow program to the client user, the at least one suggested workflow program comprising the selected workflow program.
Clause 18: The system of any of clauses 15-17, wherein the at least one suggested workflow program is determined based at least partially on a change in law or regulation.
Clause 19: The system of any of clauses 15-18, wherein the at least one processor is further programmed or configured to: display, to the client user, a search interface configured to receive at least one search parameter; querying metadata associated with the plurality of workflow programs based on the at least one search parameter to identify at least one workflow program matching the at least one search parameter; and display the at least one workflow program to the client user, the at least one workflow program comprising the selected workflow program.
Clause 20: The system of any of clauses 15-19, wherein the workflow data comprises metadata including the at least one element of metadata, the metadata comprising at least one of the following: a service agreement, an identification of at least one advisor contract, a description of a workflow program, a form, a role associated with the workflow program, an individual advisor associated with the workflow program, or any combination thereof.
Clause 21: The system of any of clauses 15-20, wherein the at least one processor is further programmed or configured to: receive, from the client, input data in response to at least one of the following: a questionnaire, a form, a prompt, or any combination thereof; and configuring the executable workflow based at least partially on the input data.
Clause 22: The system of any of clauses 15-21, wherein the input data comprises the entity data.
Clause 23: The system of any of clauses 15-22, wherein generate the workspace environment comprises modifying an existing workspace environment to include the selected workflow program.
Clause 24: The system of any of clauses 15-23, wherein generate the workspace environment comprises generate at least one graphical user interface configured to access data in an existing workspace environment.
Clause 25: The system of any of clauses 15-24, wherein the at least one processor is further programmed or configured to: receive, from the client user, a filter identifying a subset of entity data; and retrieving the subset of entity data based on the filter.
Clause 26: The system of any of clauses 15-25, wherein the at least one processor is further programmed or configured to: receive, from the advisor user, a filter identifying requested entity data; communicate, to the client user, a data access request based on the filter; and receive, from the client user, an approval or denial of the data access request.
Clause 27: The system of any of clauses 15-26, wherein the at least one processor is further programmed or configured to: generate a dashboard graphical user interface accessible by the client user, the dashboard graphical user interface comprising an identification of an advisor and/or an advisor contract associated with the selected workflow program.
Clause 28: The system of any of clauses 15-27, wherein the selected workflow program comprises at least one node configured to generate a prompt to the client user to request a review of data or a document.
Clause 29: A computer program product comprising at least one non-transitory medium including program instructions that, when executed by at least one processor, cause the at least one processor: provide an interactive graphical user interface to a plurality of advisor users, the interactive graphical user interface configured to facilitate each advisor user to create at least one workflow program; receive, from the plurality of advisor users, a plurality of workflow programs, each workflow program comprising at least a portion of an executable workflow; receive, from the plurality of advisor users, workflow data associated with the plurality of workflow programs, the workflow data comprising at least one element of metadata; host, on a platform accessible to a plurality of client users, the plurality of workflow programs in association with the workflow data; receive, from a client user of the plurality of client users, a selected workflow program of the plurality of workflow programs, the selected workflow program associated with an advisor user of the plurality of advisor users; generate a workspace environment accessible to the advisor user corresponding to the selected workflow program, the workspace environment based on the at least a portion of the executable workflow associated with the selected workflow program; populate the workspace environment with entity data received from or identified by the client user to configure an executable workflow; and automatically execute the executable workflow in response to at least one of the following: a user request, a scheduled time, a change in law or regulation, a change in entity data, or any combination thereof.
Clause 30: The computer program product of clause 29, wherein the workspace environment comprises a second interactive graphical user interface configured to visualize the executable workflow and modify the executable workflow based on input received from the advisor user through the second interactive graphical user interface or received from the client user through a prompt.
Clause 31: The computer program product of clauses 29 or 30, wherein the program instructions further cause the at least one processor to: determine at least one suggested workflow program based at least partially on an entity footprint associated with an entity of the client user; and display the at least one suggested workflow program to the client user, the at least one suggested workflow program comprising the selected workflow program.
Clause 32: The computer program product of any of clauses 29-31, wherein the at least one suggested workflow program is determined based at least partially on a change in law or regulation.
Clause 33: The computer program product of any of clauses 29-32, wherein the program instructions further cause the at least one processor to: display, to the client user, a search interface configured to receive at least one search parameter; querying metadata associated with the plurality of workflow programs based on the at least one search parameter to identify at least one workflow program matching the at least one search parameter; and display the at least one workflow program to the client user, the at least one workflow program comprising the selected workflow program.
Clause 34: The computer program product of any of clauses 29-33, wherein the workflow data comprises metadata including the at least one element of metadata, the metadata comprising at least one of the following: a service agreement, an identification of at least one advisor contract, a description of a workflow program, a form, a role associated with the workflow program, an individual advisor associated with the workflow program, or any combination thereof.
Clause 35: The computer program product of any of clauses 29-34, wherein the program instructions further cause the at least one processor to: receive, from the client, input data in response to at least one of the following: a questionnaire, a form, a prompt, or any combination thereof; and configuring the executable workflow based at least partially on the input data.
Clause 36: The computer program product of any of clauses 29-35, wherein the input data comprises the entity data.
Clause 37: The computer program product of any of clauses 29-36, wherein generate the workspace environment comprises modifying an existing workspace environment to include the selected workflow program.
Clause 38: The computer program product of any of clauses 29-37, wherein generate the workspace environment comprises generate at least one graphical user interface configured to access data in an existing workspace environment.
Clause 39: The computer program product of any of clauses 29-38, wherein the program instructions further cause the at least one processor to: receive, from the client user, a filter identifying a subset of entity data; and retrieving the subset of entity data based on the filter.
Clause 40: The computer program product of any of clauses 29-39, wherein the program instructions further cause the at least one processor to: receive, from the advisor user, a filter identifying requested entity data; communicate, to the client user, a data access request based on the filter; and receive, from the client user, an approval or denial of the data access request.
Clause 41: The computer program product of any of clauses 29-40, wherein the program instructions further cause the at least one processor to: generate a dashboard graphical user interface accessible by the client user, the dashboard graphical user interface comprising an identification of an advisor and/or an advisor contract associated with the selected workflow program.
Clause 42: The computer program product of any of clauses 29-41, wherein the selected workflow program comprises at least one node configured to generate a prompt to the client user to request a review of data or a document.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying figures, in which:

FIG. 1 illustrates a system for generating and executing a workflow program according to non-limiting embodiments;

FIG. 2 illustrates example components of a computing device used in connection with non-limiting embodiments;

FIG. 3 illustrates a flow chart for a method for generating and executing a workflow program according to non-limiting embodiments;

FIG. 4 illustrates an advisor dashboard GUI according to non-limiting embodiments;

FIGS. 5-11 illustrate additional workflow data GUIs according to non-limiting embodiments;

FIG. 12 illustrates a workflow program directory GUI according to non-limiting embodiments;

FIG. 13 illustrates a workflow program details GUI according to non-limiting embodiments;

FIG. 14 illustrates a client dashboard GUI according to non-limiting embodiments;

FIG. 15 illustrates an add workspace GUI according to non-limiting embodiments;

FIGS. 16A and 16B illustrate a workspace GUI according to non-limiting embodiments;

FIG. 17 illustrates a further workspace GUI according to non-limiting embodiments;

FIG. 18 illustrates a data access request GUI according to non-limiting embodiments; and

FIG. 19 illustrates a further data access request GUI according to non-limiting embodiments.

### DETAILED DESCRIPTION

It is to be understood that the embodiments may assume various alternative variations and step sequences, except where expressly specified to the contrary. It is also to be understood that the specific devices and processes described in the following specification, are simply exemplary embodiments or aspects of the disclosure. Hence, specific dimensions and other physical characteristics related to the embodiments or aspects disclosed herein are not to be considered as limiting. No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Also, as used herein, the terms “has,” “have,” “having,” or the like are intended to be open-ended terms. Further, the phrase “based on” is intended to mean “based at least partially on” unless explicitly stated otherwise.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. A computing device may also be a desktop computer or other form of non-mobile computer.

As used herein, the term “entity data” may refer to parameters relating to an organization, such as corporate structure, subsidiary information, country-specific information, shareholder information, historical tax information, financial information, and/or the like. An organization may be, in some examples, a multi-national organization or a local, regional, and/or national organization. Entity data may include entity names, entity countries, entity ownership, a list of directors, date of creation, date of dissolution, sale, disposition, and/or the like.

As used herein, the term “transaction data” may refer to parameters relating to transactions conducted by a multi-national organization, such as accounts receivable, accounts payable, dividend information, items or services at-issue in a transaction, dates and times for transactions, and/or the like.

As used herein, the terms “rules data” may refer to parameters relating to laws, rules, and/or regulations, including but not limited to tax rules, including tax laws, tax regulations, tax guidance, and/or the like. Rules data may include both organization-specific information, such as configured rules used by a multi-national organization, in addition to information that is not specific to an organization, such as public tax laws and databases.

As used herein, the term “node” may refer to a visual representation of one or more actions. Such actions may be performed automatically by one or more computing devices and/or may be performed manually by a user. For example, a node may be represented by a graphical element that can be arranged on a display screen.

As used herein, the term “workflow” may refer to an arrangement of one or more nodes in one or more sequences. For example, a workflow may include a plurality of nodes connected in a sequence. A workflow may be linear or in other examples may include branching logic with different paths of nodes.

As used herein, the term “workflow program” may refer to a portion of one or more workflows that can be configured into a completed workflow with inputs. As an example, a workflow program may include a workflow template that can be completed with one or more workflow parameters to create an executable workflow. A workflow program may include, for example, a template of a sequence of nodes corresponding to a sequence of actions (e.g., automated and/or performed by a user) connected with execution logic that affects the order, timing, and/or functions of actions. Such templates may be used as a foundation on which a completed and executable workflow is created after one or inputs (e.g., entity data, rules data, customization data, and/or the like) are provided. In some examples, a workflow program may include multiple workflow templates.

As used herein, the term “workflow data” may refer to data representing an overall structure of a workflow and/or workflow program, such as a sequence of nodes, and may include predefined templates, predefined complete workflows, and/or the like.

As used herein, the term “configuration data” may refer to parameters used to define one or more aspects of a workflow, workflow program, and/or a node thereof, such as a sequence of nodes, actions for nodes, roles for nodes, and/or the like. Configuration data may be part of or separate from workflow data.

As used herein, the term “workspace environment” may refer to a data resource for visualizing at least a portion of a workflow program and facilitating user interaction with workflow data, entity data, and/or configuration data. For example, a workspace environment may include a repository (e.g., data lake) that includes one or more interactive graphical user interfaces (GUIs) for visualizing and/or interacting with the workflow program, documents, databases, workflow tools, analytic tools, selectable options, and/or the like to create or configure a workflow program (e.g., add/or remove nodes, modify workflow data, configuration data, and/or execution logic, etc.) and/or to execute a completed workflow based on the workflow program.

As used herein, the term “footprint” may refer to a unique profile for one or more entities that include values for a plurality of parameters, including but not limited to jurisdictions and/or regions of operation, employee statistics, financial statistics, and/or the like. For example, a multi-national organization footprint may be generated based on a multi-national organization chart (e.g., multi-national organization data representative of corporate structure, subsidiary information, and/or the like).

Non-limiting embodiments provide for a system, method, and computer program product for generating and executing a workflow program for automatically preparing electronic documents. Through the use of interactive GUIs, advisor users are enabled to create and configure customized workflow programs that may be used for multiple clients (e.g., such as but not limited to MNEs) and improve upon the use of computing resources, including the numbers of communications that are made and processed, as compared to other document preparation methods which involve duplication, misdirected queries, and/or the like. Further, a unique arrangement of systems, GUIs, and databases is described herein for providing for dynamic, customizable workflows through the use of workflow programs and a workspace environment to create, modify, and share such workflow programs. Workflows and the components thereof are described in International Patent Application No. PCT/US2022/20314, filed on Mar. 15, 2022 and titled “System, Method, and Computer Program Product for Automatically Preparing Documents for a Multi-National Organization,” the disclosure of which is hereby incorporated by reference in its entirety.

Non-limiting embodiments facilitate advisor users to participate in a workflow program directory by making workflow programs available for client selection and, once selected, to facilitate a high-touch and remote interaction that customizes the workflow program for the client. Once a workflow program is complete, non-limiting embodiments allow for continued execution, interactions, and dynamically updating based on changes to tax rules and a footprint of the entity.

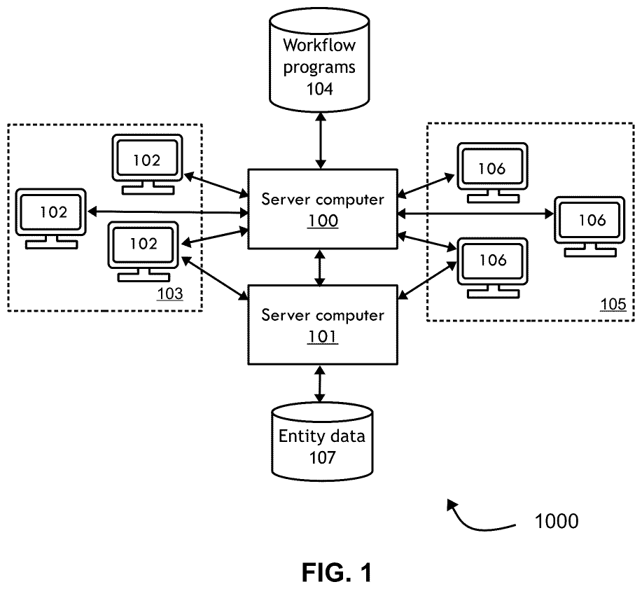

FIG. 1 shows a system 1000 for generating and executing a workflow program for automatically preparing electronic documents. The system 1000 includes a server computer 100, which may be a computing device operating in a network environment. The server computer 100 may be in communication with one or more data storage devices 104, 107 through local and/or remote communication paths. In the example shown, the server computer 100 is in communication a data storage device 104 having workflow programs stored thereon. The data storage device 104 may include, for example, workflow programs and associated workflow data, configuration data, workspace environments, and/or the like. It will be appreciated that various arrangements of data storage devices and data structures may be used, and that the data may be stored on one or more data storage devices that are local or remote to the server computer 100. It will also be appreciated that, in some examples, the data may be stored by a service which provides the data via an Application Programming Interface (API) from hosted arrays of storage devices.

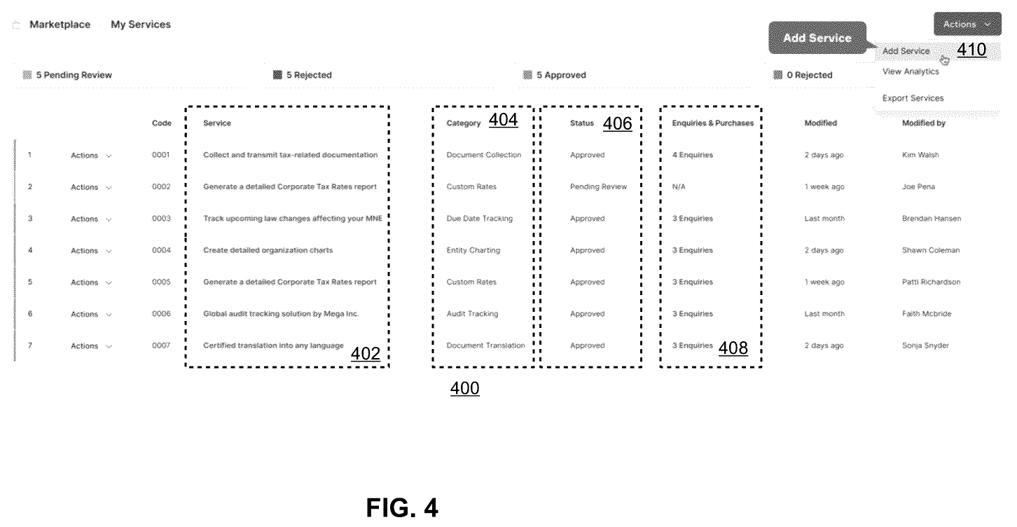

With continued reference to FIG. 1, a plurality of advisor computing devices 103 may be in communication with the server computer 100 via one or more networks. The advisor computing devices 103 may each display an advisor GUI 102. The advisor GUI 102 may include one or more GUIs configured to facilitate an advisor user to create and manage one or more workflow programs (e.g., as shown in FIGS. 4-11 and 18 according to non-limiting embodiments). An advisor user may include, for example, a tax advisor, tax attorney, consultant, accountant, and/or any user that seeks to create workflow programs and make them available to others. An advisor user may be associated with an individual user and/or a group of users (e.g., such as a consulting firm or subset thereof). The workflow programs may be created using client-side (e.g., on computing devices 103) and/or server-side (e.g., on server computer 100) software applications. The advisor GUI 102 may include one or more GUIs configured to facilitate an advisor user to input (e.g., select, type, upload, and/or the like) workflow data associated with one or more workflow programs.

The workflow data may include metadata for the workflow program, such as at least one advisor contact, a description of the workflow program, one or more images, a pricing structure, one or more categories, one or more tags (e.g., keywords or classifiers, such as but not limited to a topic, jurisdiction, and/or the like), one or more display options, requirements for the workflow, and/or the like. The workflow data may also include, for each workflow program and/or for each advisor, a service agreement and/or other contracts and documents associated with a workflow program and/or an advisor user. Through the advisor GUI 102, advisor users may create and/or manage one or more workflow programs and make the workflow programs available through a workflow directory platform that includes searchable workflow programs from multiple advisor users. In examples in which a client-side (e.g., on computing devices 103) software application is used to create a workflow program, the workflow program may be uploaded to the server computer 100. In examples in which the server computer 100 hosts the software application for creating the workflow program (e.g., as Software-as-a-Service), the server computer 100 may save the workflow program in the data storage device 104.

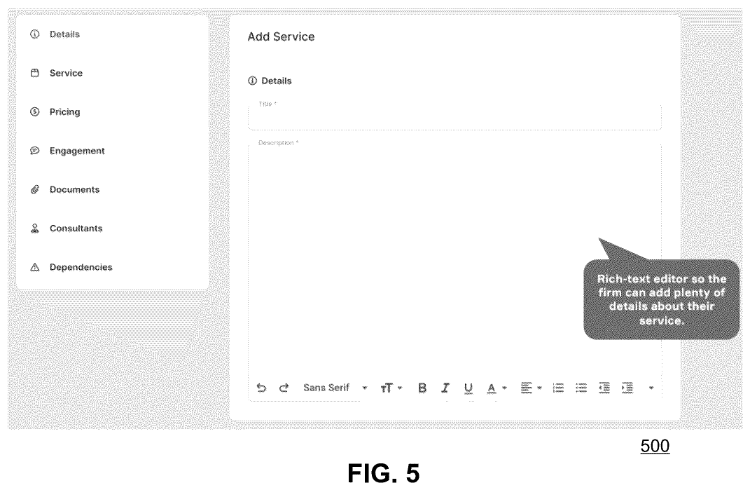

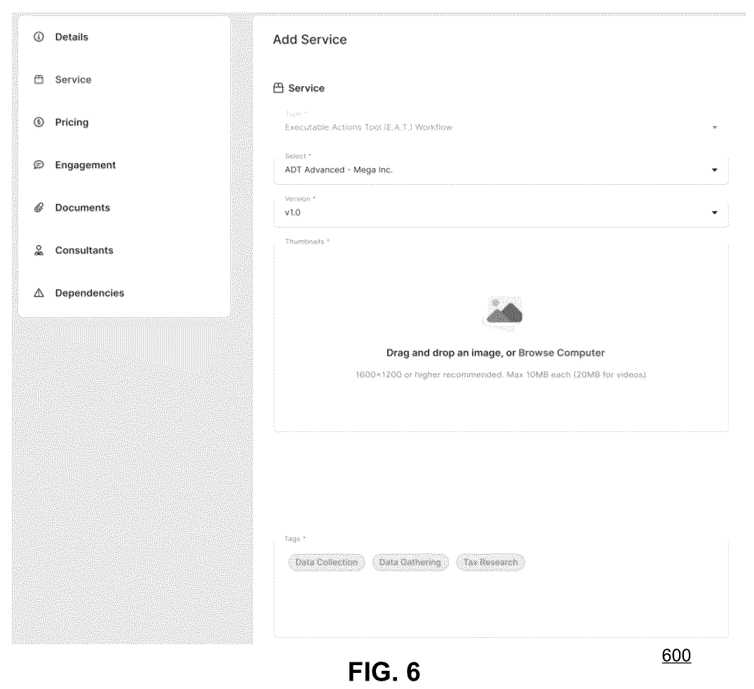

Still referring to FIG. 1, the server computer 100 may host a workflow directory platform that is accessible to a plurality of computing devices 105 operated by client users (e.g., individuals, corporations, multi-national organizations, and/or the like). The workflow directory platform may include, for example, a web service or private network service hosted by the server computer 100 and made viewable through one or more GUIs 106 displayed on the computing devices 105 of client users. As an example, the computing devices may access the workflow directory through a web browser or another software application that is in communication with the server computer 100. The GUIs 106 may provide selectable options and tools for the user to search and/or browse a plurality of workflow programs stored in the data storage device 104 (e.g., as shown in FIGS. 5 and 6 according to non-limiting embodiments). For example, the GUIs 106 may include text entry fields, checkboxes, buttons, drop-down menus, and/or the like to enable a user to search the workflow data associated with each workflow program. In this manner, the workflow directory platform serves as a marketplace for workflow programs provided by multiple advisor users (e.g., associated with the plurality of computing devices 103) that a client user (e.g., associated with one of the plurality of computing devices 105) may select and engage with. In some examples, a client user may enter into an arrangement with one or more of the advisor users to implement and execute a workflow program. In non-limiting embodiments, the GUIs 106 may present click-through agreements, payment interfaces, and/or other like tools for a user to enter into an arrangement with an advisor user (or group of advisor users).

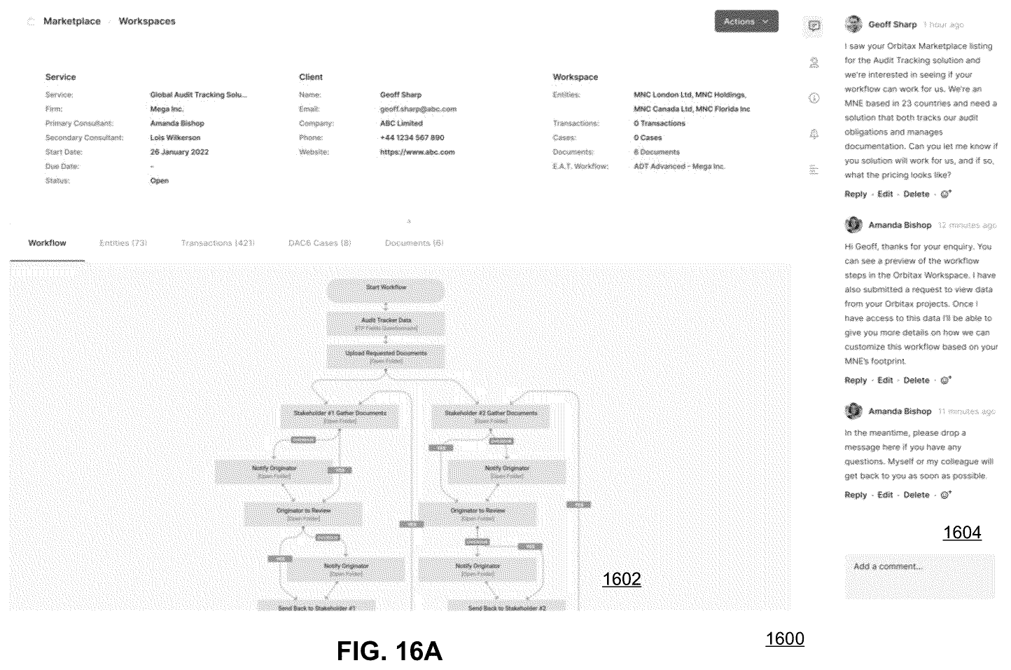

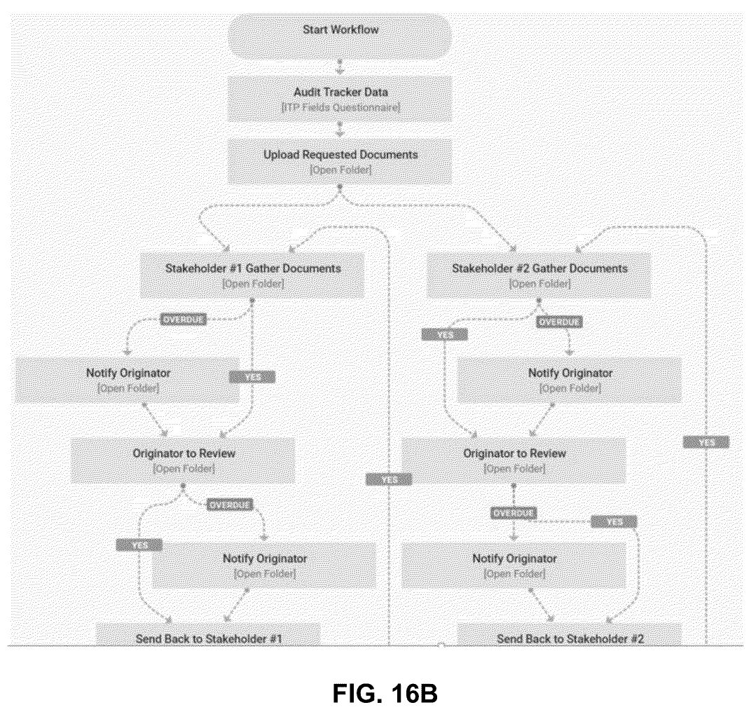

With continued reference to FIG. 1, a server computer 101 may host a workspace environment accessible to at least one advisor computing device 103 and at least one user computing device 105 associated with an entity (e.g., as shown in FIG. 16A according to a non-limiting embodiment). For example, the workspace environment may be accessible via a web browser and/or a client-side application that accesses the server computer 101 over a network. Although FIG. 1 shows server computer 100 and server computer 101 as two separate devices, it will be appreciated that in non-limiting embodiments a single server computer may be used to perform the functions described herein with respect to both server computer 100 and server computer 101, and in other non-limiting embodiments multiple server computers (e.g., physical or virtual) may be used to perform such functions. The workspace environment may include interactive GUIs depicting a visual workflow based on the one or more workflow programs and may be made accessible to both advisor user(s) and client users. In non-limiting embodiments, the views (e.g., GUIs) and/or permissions provided to the advisor user(s) and client user(s) may differ. In non-limiting embodiments, the advisor user(s) and client user(s) may engage (e.g., enter into an agreement or the like) through the workspace environment. In other non-limiting embodiments, the advisor user(s) and client user(s) may engage prior to generating and/or assigning the workspace environment.

With continued reference to FIG. 1, through the workspace environment the advisor user may interact with the workflow program, add and/or modify workflow parameters, import data, and/or prompt involvement of other users. Data may be imported into the workflow program and used to create an executable workflow by obtaining the data from one or more data resources (e.g., pulling the data via one or more APIs, database connections, and/or the like) and/or being provided the data from one or more users (e.g., users pushing the data to the server computer 101). For example, a user may upload entity data 107 and/or other data related to an organization that may be used as parameters in the workflow program. In non-limiting embodiments, the workflow program may be a template (e.g., an incomplete workflow) that is made into an executable workflow by providing inputs, such as workflow parameters, to complete and/or customize the template through the workspace environment.

In non-limiting embodiments, the advisor user(s) and/or client user(s) may configure a workflow starting from the workflow program and using various drag-and-drop modules, drop-down menus, buttons, links, checkboxes, input fields, slide bars, and/or other like tools presented in the workflow environment. The workspace environment may also present one or more visual representations of workflow data. Through the workspace environment, as an example, users may be provided tools for assigning one or more roles to one or more nodes and/or actions, modifying a sequence of nodes, adding due dates, adding nodes, removing nodes, specifying a filter (e.g., one or more parameters for retrieving a subset of data from a larger data set), specifying an algorithm, and/or other configuration details that a user may wish to specify and/or adjust.

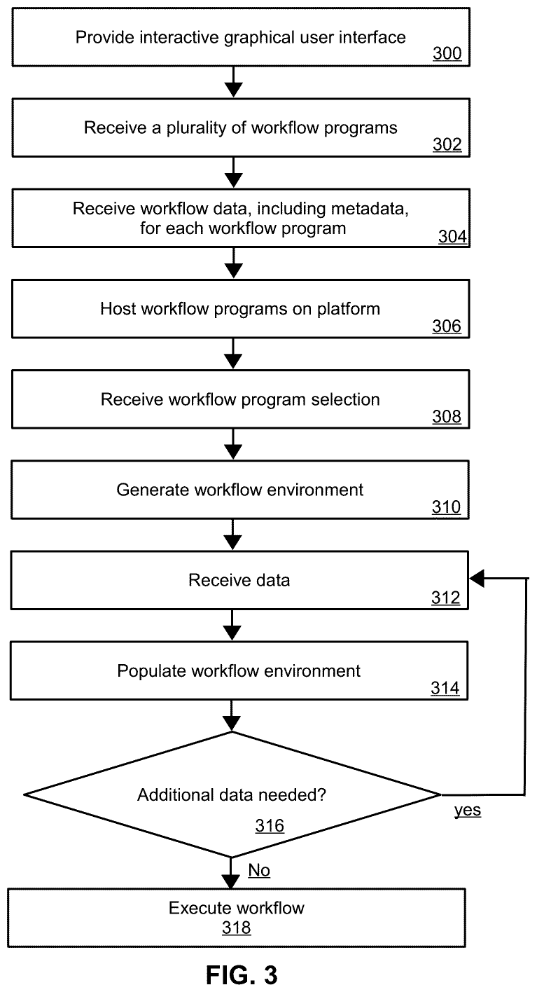

Referring now to FIG. 3, a flow chart is shown for a method of generating and executing a workflow program for automatically preparing electronic documents according to non-limiting embodiments. It will be appreciated that additional steps, fewer steps, different steps, and/or a different order of steps may be used in non-limiting embodiments, and that the flow chart shown in FIG. 3 is shown as an example. At step 300, an interactive GUI is provided to advisor users. For example, one or more interactive GUIs may be provided to a plurality of advisor users through individual computing devices that access the GUIs through a server. Additionally or alternatively, client-side software applications may be utilized by the advisor users that provide the GUIs and communicate inputs and/or data to a server.

At steps 302 and 304, the advisor users, through the interactive GUI, create, maintain, update, and/or upload workflow programs and workflow data associated with such workflow programs such that the workflow programs and associated workflow data are received and stored by a server computer. The advisor users may also use the interactive GUI to configure a profile (e.g., information, logo, contact information, website, and/or the like) for individual advisors and/or firms or groups of advisors. In non-limiting embodiments, advisor users may categorize workflow programs (e.g., assigning classifications and/or organizing workflow programs into folders, subfolders, and/or the like). In non-limiting embodiments, workflow data provided at step 304 may include metadata for a workflow program, such as at least one advisor contact, a description of the workflow program, one or more images, a pricing structure, one or more categories, one or more tags (e.g., keywords or classifiers, such as but not limited to a topic, jurisdiction, and/or the like), one or more display options, requirements for the workflow, and/or the like. In non-limiting embodiments, the workflow data may include documents such as a service agreement for engaging the advisor.

At step 306, the server computer hosts the workflow programs received from the advisor users on a workflow directory platform that is accessible to client users (e.g., individuals, corporations, multi-national organizations, and/or the like). As an example, the client users may access the workflow directory through a web browser or another software application that is in communication with the server. The workflow directory platform may include selectable options and tools for a client user to search and/or browse a plurality of workflow programs provided by the plurality of different advisor users. For example, the GUIs may include text entry fields, checkboxes, buttons, drop-down menus, and/or the like to enable a user to search the workflow data associated with each workflow program. In this manner, the workflow directory serves as a marketplace for workflow programs provided by multiple advisor users that client users may select from to use.

In non-limiting embodiments, a client user may browse and/or search some or all of the workflow programs. The workflow programs available for a client user to view in some examples may depend upon permissions, subscriptions, licenses, and/or the like. For example, a client user may choose a topic (e.g., a tax type or event) to browse related workflow programs, and/or may search the workflow programs (e.g., may search the metadata associated with the workflow programs by keyword, tag, description, jurisdictions (e.g., countries, states, and/or the like), years, and/or other like parameters). In some non-limiting embodiments, one or more workflow programs may be automatically recommended to a user based on information provided by the user, such as entity data. For example, one or more workflow programs may be suggested based on a footprint of the entity associated with the client user.

At step 308, the system receives a user selection of one or more workflow programs (e.g., a selected workflow program). In some examples, after selecting a workflow program, a client user may enter into an arrangement with one or more of the advisor users to implement and execute the workflow program. In non-limiting embodiments, the GUIs may present click-through agreements, payment interfaces, and/or other like tools for a client user to enter into an arrangement with an advisor user (or group of advisor users) relating to one or more workflow programs.

At step 310, a workspace environment is generated for the one or more workflow programs selected by the user at step 308. The workspace environment may be viewable by one or more advisor users associated with the workflow program. For example, the one or more advisor users may include the advisor user that created and/or uploaded the workflow program, an advisor user associated with the advisor user that created and/or uploaded the workflow program (e.g., part of the same group or firm), a separate advisor user, and/or the like. In some non-limiting embodiments, the workspace environment may be generated in response to the client user initially selecting a workflow program from the workflow program directory such that the engagement with the advisor user(s) and/or the negotiation leading up to such engagement (e.g., including click-through agreements, payment interfaces, and/or other like tools for a client user to enter into an arrangement with an advisor user) occurs within the workspace environment. In some non-limiting embodiments, the workspace environment may be generated after the client user engages the advisor user(s).

In some non-limiting embodiments, the workspace environment may be accessible by the client user that selected the workflow program and/or other client users associated with an entity that selected the workflow program. In non-limiting embodiments, generating the workspace environment may include automatically modifying an existing workspace environment based on the one or more workflow programs. The existing workspace environment may be for recurrent tax filings, such as monthly declarations for VAT tax in some jurisdictions, or for any other purpose. In some non-limiting embodiments, a new workspace environment may be created that is the same for various different workflow programs or that is customized based on the workflow programs. In non-limiting embodiments, one or more elements of workflow data provided by the advisor user at step 304 (e.g., such as one or more display options, requirements for the workflow, and/or the like) may be used to generate the workspace environment (e.g., may be used to arrange the workspace environment and/or may affect the options available through the workspace environment).

In non-limiting embodiments, generating the workspace environment includes generating at least one GUI configured to view and modify the workflow program, access and view associated data (e.g., workflow data, entity data, rules data, and/or the like), and/or manage one or more aspects of the workspace environment (e.g., permissions for who can access). In non-limiting embodiments, one or more client users may be presented with a dashboard GUI that displays one or more workflow programs, one or more advisors associated with one or more workflow programs, and/or other information. In non-limiting embodiments, access to the workspace environment may be suspended in response to an event, after a period of time (e.g., after a year or other time period), and/or at a scheduled (e.g., predetermined) time. The workflow data associated with a workflow program may include one or more conditions for suspension, applicable time period, and/or an expiration date.

At step 312, data is received from the client user and/or other sources to complete the workflow program and create an executable workflow. For example, entity data, rules data, preference data, and/or the like may be obtained from one or more data resources. In some examples, the data may be “pulled” such that a server computer retrieves the data from other systems via one or more APIs, database connections, and/or the like. In some examples, the data may be “pushed” such that client users may provide the data to the server by uploading it. Such uploading may be prompted through one or more GUIs that ask for a client user to provide particular information. In some non-limiting embodiments, a client user may select data that the advisor user and/or workspace environment can obtain through permissions. In some non-limiting embodiments, the data may be obtained from the system through authorization by the client user. For example, a client user may have previously authorized access to entity data (e.g., entity data stored in the data storage device 107 in FIG. 1) that was already uploaded or provided to the system (e.g., to the server computer 101 in FIG. 1). In some examples, the client user may be prompted to authorize the access for the data, such as but not limited to entity data, that was previously provided.

In some non-limiting embodiments, the workflow data for a workflow selected at step 308 may include an identification of the data needed for that workflow so that client users are aware of the data that will have to be shared. In non-limiting embodiments, one or more filters may control the data that is provided. For example, if the data is “pushed” from the client user, the client user may configure a filter that identifies a subset of entity data and/or transaction data for populating the workspace environment and/or for being available to one or more advisor user(s). If the data is “pulled” from the client user, the advisor user may configure a filter (e.g., which may be part of the workflow data or later defined) that is used to generate a data access request. In such examples, the data access request may be communicated to a client user as a message that prompts the client user for approval (e.g., authorization) and facilitates access to the data identified by the filter. The client user's authorization may be a “pipeline permission” that specifies a subset of data to which the system and/or advisor user(s) may be provided access to. The client user's authorizations specified in a client-configured filter may be for all workflow programs selected by the client user or in other examples may be per each individual workflow program. In some examples, an advisor user may cause a prompt to be displayed to a client user to request review of data and/or one or more documents from a client user. In non-limiting embodiments, the prompts may be automatically generated and communicated to the client user based on the workflow program or may be triggered by the advisor user.

At step 314, the workspace environment is populated with the data obtained at step 312. For example, the data may be used to customize, configure, and/or complete one or more aspects of a workflow program. In non-limiting embodiments, populating the workspace environment may be performed at least partially automatically in response to all of the data missing from the workflow program being provided at step 312. For example, as incomplete portions of a template workflow are completed with data provided by the advisor user(s) and/or the client user(s), corresponding portions of the workflow program may be completed. In some examples, the advisor user and/or client user may populate some or a portion of the data.

At step 316, it may be determined if additional data is needed to complete the workflow program such that the workflow can be executed. For example, if any parameters are missing from the workflow program, the system may generate and display an alert to identify the information that is still needed. In some examples, the workspace environment may include a list of data needed for executing a workflow based on the workflow program. If additional data is needed at step 316, the method may proceed back to step 312. For example, an advisor user and/or client user may be prompted to provide data needed to complete the workflow program. In non-limiting embodiments, the workflow program may include workflow nodes that prompt advisor user(s) and/or client user(s) for input. For example, completing the workflow program may include prompting one or more advisor user(s) to review data and/or one or more documents that have been input by a client user.

If the workflow program is completed at step 316, the method may proceed to step 318 and the workflow may be executed. The workflow may be automatically executed in response to a predetermined event, such as a particular date and/or time (e.g., a scheduled execution time), or may be executed in response to input from a user (e.g., an advisor user). In non-limiting embodiments, the server computer may execute a workflow program by performing actions associated with each node in the sequence of the workflow. In some examples, the server computer performs an action by issuing an instruction to at least one other system or application that, in response to the instruction, may perform a corresponding action. Executing a workflow based on the workflow program may include sending requests for data and/or permissions to access data, reviewing the data that is obtained from requests or access, performing calculations (e.g., tax calculations), preparing forms and/or documents, reviewing forms and/or documents, and/or filing forms and/or documents, as examples. It will be appreciated that different workflows may include different actions and sequences of actions. In some examples, the server computer may determine that information for performing an action is not available and/or is not specified. In such examples, the server computer may automatically generate and communicate a query for the missing information to one or more users (e.g., advisor users and/or client users). The users queried may be determined based on roles that are predefined and/or specified by the advisor user when creating the workflow program and/or by the advisor user or client user within the workspace environment.

FIG. 4 shows an advisor dashboard GUI 400 according to non-limiting embodiments. A list of services 402 associated with an advisor or advisor firm may include services that correspond to one or more workflow programs. Associated with each service is a category 404 that may be populated from the metadata for a particular workflow program and a status 406 associated with the workflow program (e.g., whether the workflow program is unfinished, completed, pending approval by the system and/or regulatory entity, approved by the system and/or regulatory entity, and/or the like). Each service may also be associated with one or more inquiries (e.g., enquiries) 408 received from client users. A selectable option 410 may be provided to add a workflow program, remove a workflow program, request approval, and/or the like.

Referring now to FIGS. 5-11, GUIs are shown for adding a workflow program according to non-limiting embodiments. For example, the GUIs shown in FIGS. 5-11 may be displayed in response to an advisor user selecting an option 410 to add a workflow program. In FIG. 5, a GUI 500 is shown for adding workflow data about a workflow program, such as a title and description. The title and description may be part of the metadata associated with the workflow program as workflow data. In some examples, the advisor user may use a rich-text editor and select fonts, text sizes, and/or other like features to control how a particular workflow program may appear to client users in the workflow directory platform.

Referring now to FIG. 6, a further GUI 600 is shown for adding workflow data for a workflow program according to non-limiting embodiments. In this GUI 600, an advisor user may input (e.g., enter, select, and/or the like) further workflow data, including a type of classification for the workflow program, a version of the workflow program, one or more images and/or videos representing the workflow program, and one or more tags representing the workflow program. The tags may include, for example, “data collection,” “data gathering,” and “tax research” that may be part of the metadata associated with the workflow program. In some examples, the tags may be automatically recommended by the system based on the workflow program. In some examples, the tags may be manually entered by a user or selected from a list of tags.

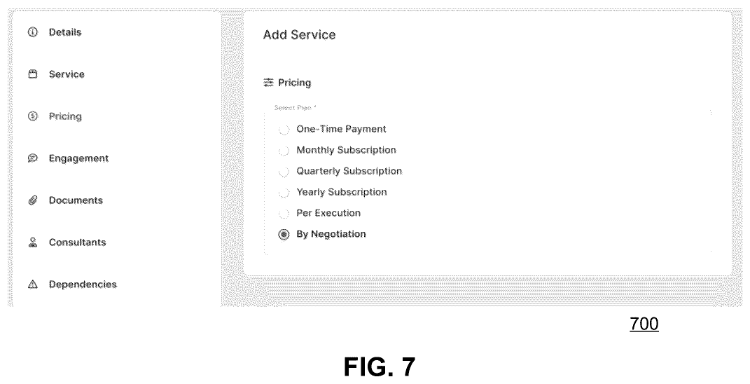

Referring now to FIG. 7, a further GUI 700 is shown for adding workflow data for a workflow program according to non-limiting embodiments. In this GUI 700, an advisor user may input (e.g., enter, select, and/or the like) pricing and/or payment terms for the workflow program. In the example shown in FIG. 7, the GUI 700 includes selectable options for an advisor to choose from a one-time payment, a monthly subscription, a quarterly subscription, a yearly subscription, a fee per execution of the workflow program, or by negotiation (e.g., customize). In non-limiting embodiments, the GUI 700 may also include an option to input one or more prices. It will be appreciated that various arrangements are possible.

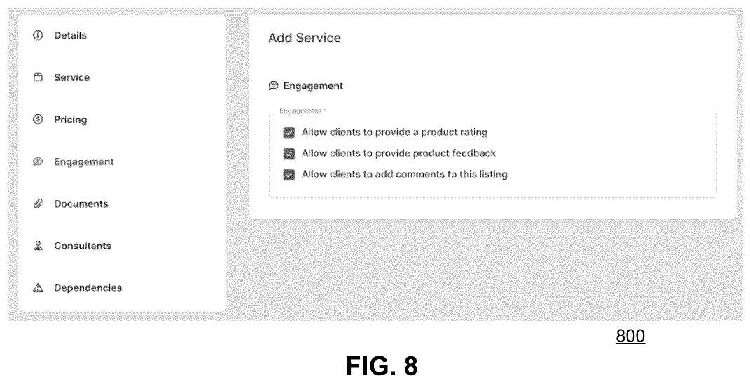

Referring now to FIG. 8, a further GUI 800 is shown for adding workflow data for a workflow program according to non-limiting embodiments. In this GUI 800, an advisor user may customize how the workflow program appears to and is interacted with client users. For example, an advisor user may allow or prohibit client users from providing a rating for the workflow program or the advisor user, feedback regarding the workflow program, and/or viewable comments associated with the listing of the workflow program on the workflow directory platform.

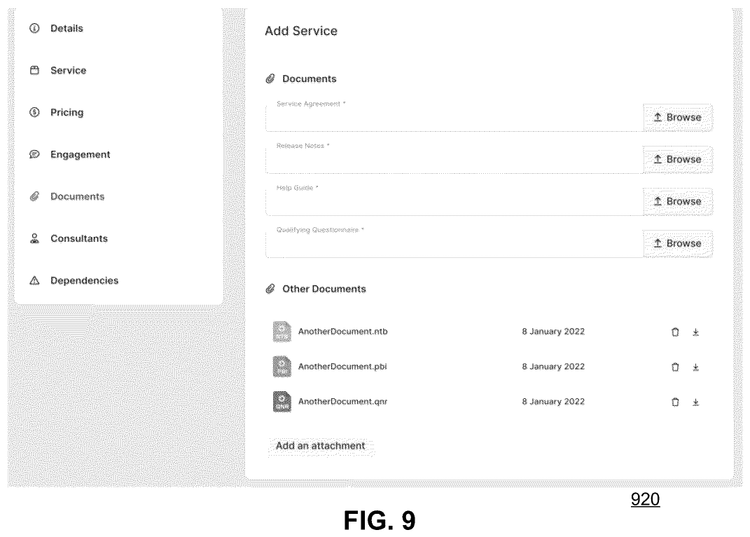

Referring now to FIG. 9, a further GUI 920 is shown for adding workflow data for a workflow program according to non-limiting embodiments. In this GUI 920, an advisor user may input one or more documents such as, for example, a service agreement, release notes about the workflow program (e.g., additional description), a help guide for the workflow program, and/or a qualifying questionnaire for a client user to determine if a workflow program is suitable. The GUI 920 may provide one or more tools for uploading documents. In some non-limiting embodiments, the GUI 920 may also include tools for creating such documents from templates or the like.

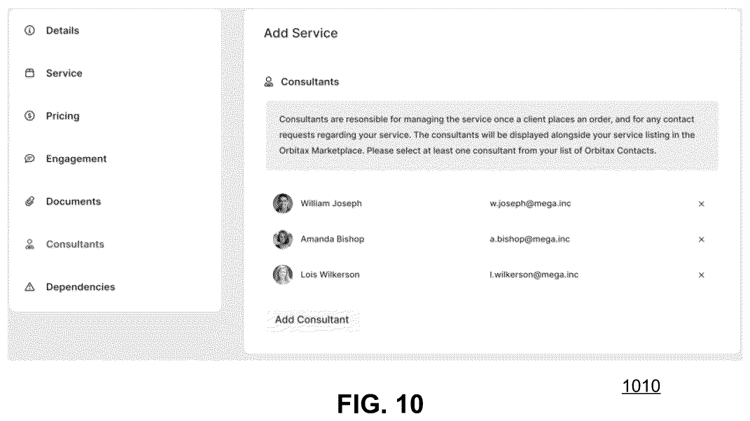

Referring now to FIG. 10, a further GUI 1010 is shown for adding workflow data for a workflow program according to non-limiting embodiments. In this GUI 1010, an advisor user may select one or more advisor users (e.g., consultants), including themselves and/or others. In some examples a workflow program may be associated with multiple advisor users. In some examples, a client user may be able to select from multiple advisor users, request a specific advisor user, and/or the like. The list of advisor users may be part of the metadata associated with the workflow program.

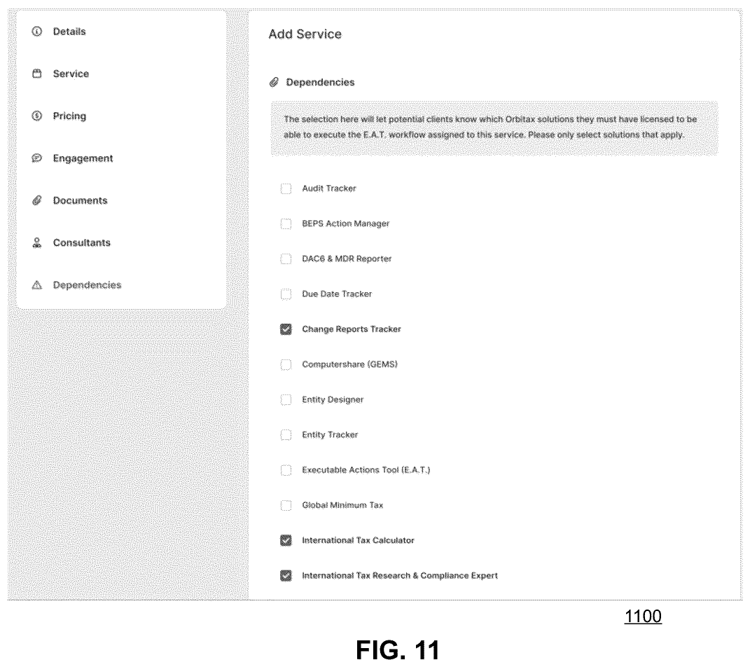

Referring now to FIG. 11, a further GUI 1100 is shown for adding workflow data for a workflow program according to non-limiting embodiments. In this GUI 1100, an advisor user may select one or more dependencies (e.g., subscription packages, software packages, and/or the like) that may be required for the workflow program. In some examples, the dependencies may be packages that provide different sets of tools and functionality. In non-limiting embodiments, the system may provide various different packages and/or levels of access to client users and the workflow programs available to those client users may depend on which packages and/or levels of access the client user has.

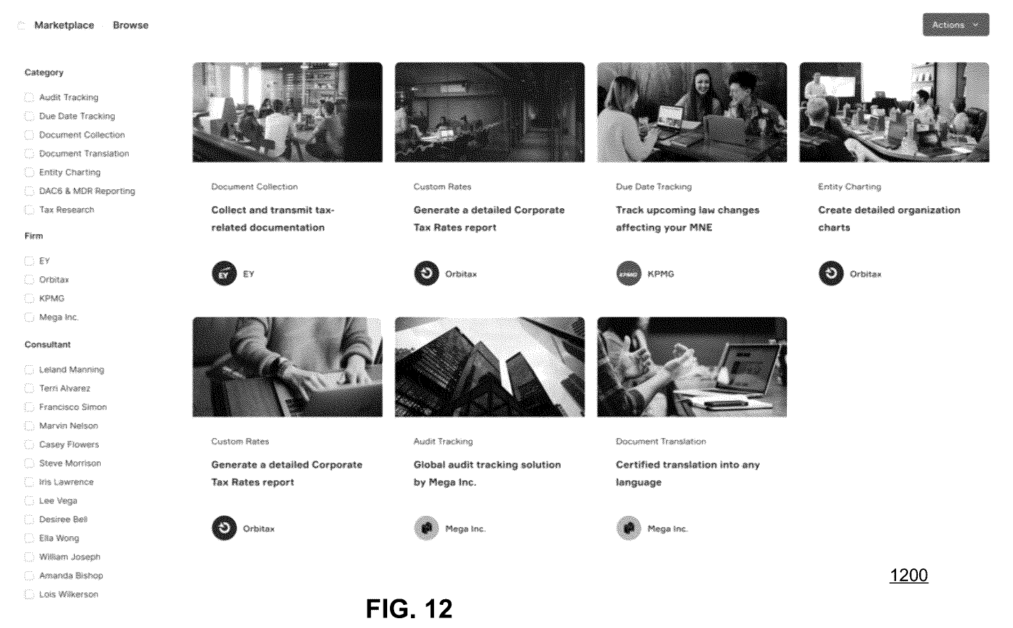

Referring now to FIGS. 12-17, GUIs are shown for interacting with client users according to non-limiting embodiments. For example, the GUIs shown in FIG. 12-17 may be displayed in response to a client user logging into a workflow program directory platform through a web browser and/or dedicated software application. In FIG. 12, a workflow program directory GUI 1200 is shown according to non-limiting embodiments. Selectable options, such as checkboxes, input fields, buttons, and/or the like, provide the ability for client users to search a plurality of workflow programs created and/or managed by a plurality of advisor users and/or firms. The workflow programs are shown in the workflow program directory GUI 1200 and provide a summary of each workflow program.

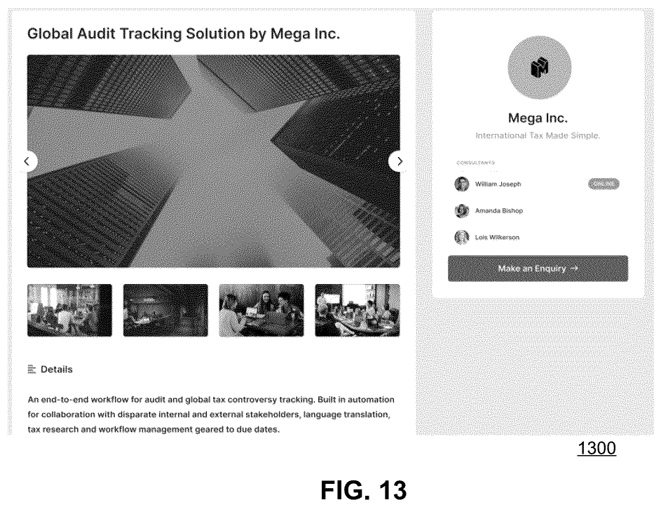

Referring now to FIG. 13, a workflow program details GUI 1300 is shown according to non-limiting embodiments. The GUI 1300 may be displayed in response to a client user selecting one of the workflow programs in the GUI 1200 shown in FIG. 12, as an example, or may be displayed in response to a client user navigating to it. The GUI 1300 displays workflow data, such as metadata including name, description, and one or more advisor users. Client users may choose a selectable option to make an inquiry and/or request engagement for a workflow program through the GUI 1300.

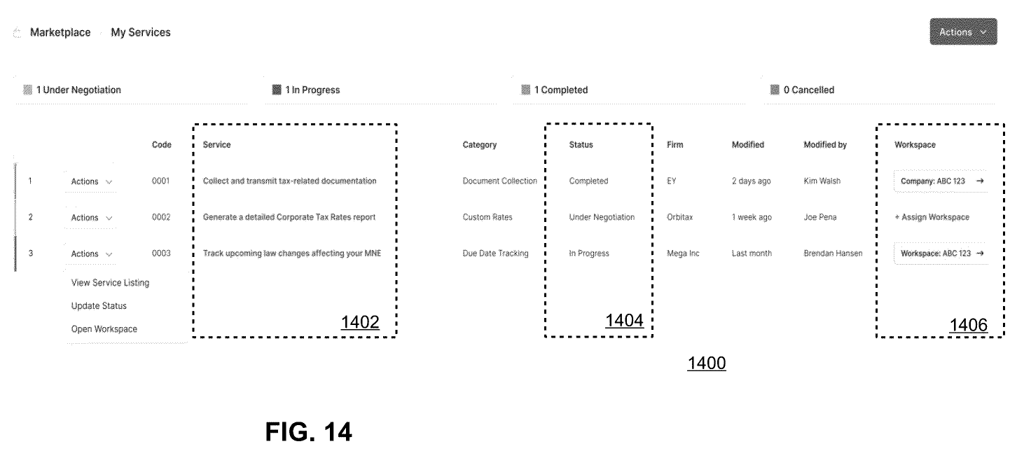

Referring now to FIG. 14, a client dashboard GUI 1400 is shown according to non-limiting embodiments. The client dashboard GUI 1400 may display one or more workflow programs for the client user, such as workflow programs that have been engaged with (e.g., subscribed to, purchased, inquired about, and/or the like) by the client user. The client dashboard GUI 1400 may display a name of each workflow program 1402 in a list associated with a current status 1404 (e.g., under negotiation, in progress, completed, and/or the like). The client dashboard GUI 1400 may further display a date each workflow program was last modified, pending action items, links to a workspace environment (e.g., workspace) 1406, a category, and/or the like. From the GUI 1400, a client user may manage one or more workflow programs being managed by one or more advisor users.

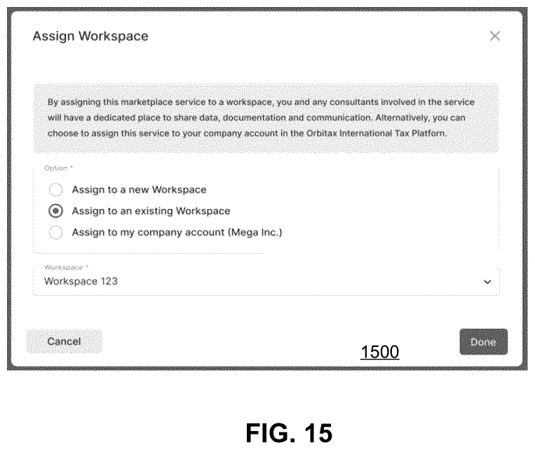

Referring now to FIG. 15, an assign workspace GUI 1500 is shown according to non-limiting embodiments. The assign workspace GUI 1500 may be configured to facilitate a client user to create and/or assign a workspace environment (e.g., workspace) to a workflow program. For example, GUI 1500 may be displayed in response to a client user selecting an option on the client dashboard GUI 1400 shown in FIG. 14.

Referring now to FIGS. 16A and 16B, a workspace GUI 1600 is shown according to non-limiting embodiments. The workspace GUI 1600 includes a workspace environment that facilitates a client user to interact with the workflow program, workflow data, and/or one or more advisor users. For example, the workspace GUI 1600 may include a visualization 1602 of the workflow program as a sequence of nodes (shown in FIG. 16B), workflow data, and/or a communication tool 1604 to communicate with one or more advisor users (e.g., such as a chat dialog box or other electronic messages). Through the workspace GUI 1600, a client user may interact with the workflow program and/or advisor user(s) to complete the workflow program into an executable workflow. For example, a client user may populate the workflow program with data (e.g., entity data, transaction data, and/or the like) to complete a template, resulting in an executable workflow.

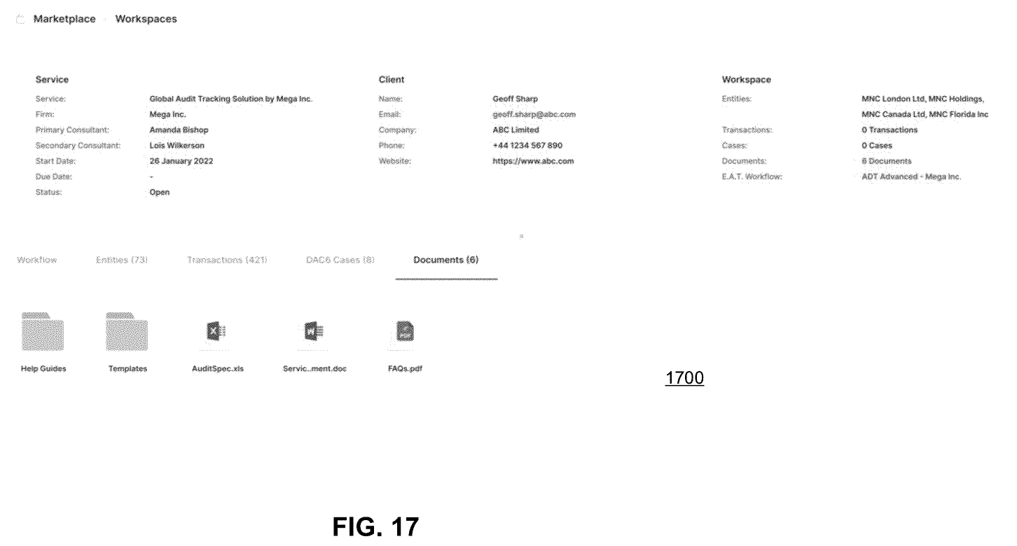

Referring now to FIG. 17, a further workspace GUI 1700 is shown according to non-limiting embodiments. The workspace GUI 1700 includes a workspace environment that facilitates a client user to input data (e.g., upload and/or enter entity data, transaction data, and/or the like). For example, the workspace GUI 1700 may include tools for uploading documents to the system and/or identifying one or more documents that are already available on a network (e.g., documents that may be used in connection with other workflow programs and/or the like).

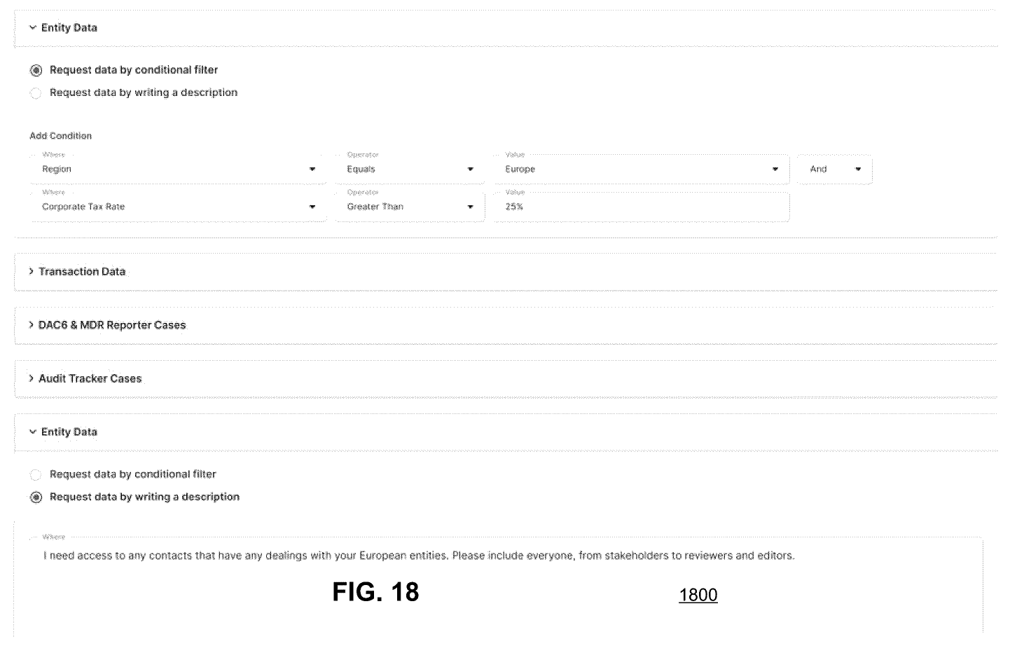

Referring now to FIG. 18, a data access request GUI 1800 is shown according to non-limiting embodiments. The data access request GUI 1800 may be displayed to an advisor user to configure. For example, the GUI 1800 shown in FIG. 18 allows for an advisor user to request data with a conditional filter or to request data with a description. The conditional filter allows for an advisor user to specify a region, corporate tax rate, aspects of transaction data, and/or the like.

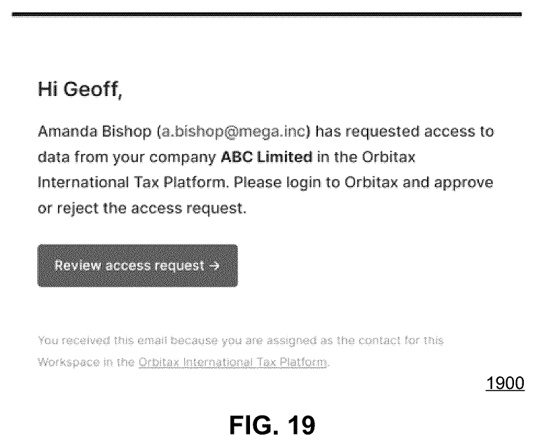

Referring now to FIG. 19, a further data access request GUI 1900 is shown according to non-limiting embodiments. The GUI 1900 may be displayed to a client user in response to an advisor user configuring the data access request in the GUI 1800 shown in FIG. 18. The GUI 1900 may prompt the client user for permission for the advisor user and/or system to access data. In some examples the data being accessed (e.g., entity data, transaction data, and/or the like) may be already hosted by the system and permissions need to be provided. In other examples, the data being accessed may be hosted by the client user or elsewhere and acceptance of the data access request may trigger a communication of the data through an API or the like.

In non-limiting embodiments, workflows may be manipulated and/or executed by a system for automatically preparing documents for an MNE, which may be operated by one or more different computing devices or the same one or more computing devices described herein for generating and executing a workflow program (e.g., the server computer 100 and/or the server computer 101). Example systems and methods for automatically preparing documents for an MNE are described in International Patent Application No. PCT/US2022/20314, filed on Mar. 15, 2022 and titled “System, Method, and Computer Program Product for Automatically Preparing Documents for a Multi-National Organization,” the disclosure of which is hereby incorporated by reference in its entirety. For example, a system for automatically preparing documents for an MNE may include a server computer, which may be a computing device operating in a network environment. The server computer may be in communication with one or more data storage devices through local and/or remote communication paths. For example, the server computer may be in communication with a multi-national organization database including multi-national organization data (e.g., entity data) stored on a first data storage device (entity database), a tax rules database including a plurality of rules stored on a second data storage device (rules database), a transaction database including transaction data stored on a third data storage device (transaction database), and a configuration database including configuration data stored on a fourth data storage device (configuration database). It will be appreciated that various arrangements of data storage devices and data structures may be used, and that the data may be stored on one or more data storage devices that are local or remote to the server computer. It will also be appreciated that, in some examples, the data may be stored by a service which provides the data via an API from hosted arrays of storage devices.

In non-limiting embodiments of systems and methods for automatically preparing documents for an MNE, a multi-national organization footprint is generated based on a multi-national organization chart (e.g., multi-national organization data representative of corporate structure, subsidiary information, and/or the like), which may be obtained from the entity database, and transaction data, which may be obtained from the transaction database. The multi-national organization footprint and tax rules data (e.g., obtained from the rules database) are used to generate a document preparation workflow having one or more stages, each stage associated with one or more nodes. In non-limiting embodiments, the document preparation workflow includes a sequence of nodes where each node is associated with an action, such as but not limited to data retrieval, data validation, data input, data manipulation, data processing, report generation, notification generation, and/or the like. The actions (e.g., steps) represented by nodes may be related to preparing and/or filing one or more documents.

In non-limiting embodiments of systems and methods for automatically preparing documents for an MNE, the server computer may be in communication with a client computing device. The client computing device may be local to and/or remote from the server computer. In non-limiting embodiments, the client computing device presents one or more GUIs to a user. The GUIs may present one or more document preparation workflows generated by the server computer as a template based on at least the multi-national organization data and the tax rules data. A user may interact with the GUIs to configure the document preparation workflow (e.g., visual workflow) by, for example, assigning one or more roles to one or more nodes and/or actions, modifying a sequence of nodes, adding due dates, adding nodes, removing nodes, specifying a filter (e.g., one or more parameters for retrieving a subset of data from a larger data set), specifying an algorithm, and/or other configuration details that a user may wish to specify and/or adjust. In non-limiting embodiments, a filter may retrieve entities within a geography (e.g., country or region), entities having revenues satisfying a threshold, and/or the like. The GUI may present different fields for each of a plurality of filter parameters.

In non-limiting embodiments of systems and methods for automatically preparing documents for an MNE, the user may configure the document preparation workflow through various drag-and-drop modules, drop-down menus, buttons, links, checkboxes, input fields, slide bars, and/or other like tools presented on the GUIs. The GUIs may also present one or more visual representations of workflow data. As an example, a filter may be processed to determine how many French entities exist for a multi-national organization having 500 or more entities. For a filter to show, for example, for all French entities, the input data may be a multi-national organization footprint (e.g., profile based on an entity chart). The output in such an example is a list of French entities. As another example, for a filter to show all of the transactions that French entities are engaged in, the input to the filter is the transaction history for those entities. The output in such an example is a list of transactions to which the French entities are parties to. As another example, for a filter to show all tax-abusive transactions the French entities are involved in, the input to the filter is the transaction history for those entities and a tax rules database (e.g., a tax-abusive transaction rules engine or database). The output in such an example is a list of abusive transactions those entities are a party to. As a further example, if the filter to show all tax-abusive transactions the French entities are involved in requires information about one or more transactions with a different entity (e.g., a Japanese entity), a query may be automatically sent to a person corresponding with a specified role (e.g., a controller for the Japanese entity) for additional input for processing the filter. The output in such an example is the response from the person with the specified role, which can be input to an additional filter.

In non-limiting embodiments of systems and methods for automatically preparing documents for an MNE, in the context of a workflow, a node with a filter may be configured to identify entities in the footprint that meet certain criteria, such as selecting all entities that qualify as Controlled Foreign Corporations (CFCs) under Argentina tax rules, which means any entity which is not a resident in Argentina, which has an Argentinian shareholder, and where the entity earns passive income. In such a case, the data on whether entities are earning passive income from an Argentina tax point of view may come from a questionnaire that asks a series of questions to get to this answer. A similar approach may be used to determine the types of reports to generate after applying the filter. In the above example, once the filter has identified the CFCs for Argentina purposes, a user could populate the CFCs data along with other data on one or more reports which could be templates in Excel, PDF, XML, etc., and the need to generate this could also be based on a questionnaire where the answers provided will determine what reports have to be generated with the filtered data.

In non-limiting embodiments of systems and methods for automatically preparing documents for an MNE, one or more questionnaires may be presented on a GUI to ask the user a series of questions that are used as conditional logic to trigger how different stages, nodes, and/or actions of the workflow will be triggered. Such questionnaires may be used to set up and/or configure the workflow, and in other examples may be used to customize an existing workflow. A questionnaire may also be communicated and sent to other users automatically based on a role of the user and a role associated with the workflow and/or portion of the workflow. Questionnaires may prompt for confirmation of one or more data elements (e.g., yes or no) or may prompt for a specific answer to be input. Questionnaires may be used during initial configuration of a workflow and/or during execution of a workflow. For example, during configuration, a user may add one or more questionnaires in any of the nodes (e.g., stages) or as a separate node to ask participants one or more questions that are used to process conditional logic (which may be specified by the user or predetermined) to trigger how different nodes of the workflow will be executed. For example, when participants are asked to review the imported entity data, the node for importing entity data may include a questionnaire for the user to respond if, during a certain time period, they were or are aware of any new entities that have been added and, if yes, to provide certain details. Similar questionnaires may be presented for entities that have been sold, liquidated, merged, had a change of ownership, change in entity type, and/or change in entity name, and for any other review stage of the workflow. In non-limiting embodiments, a questionnaire node may be a standalone node in a workflow or may be a part of another node, such as a conditional questionnaire. For example, a review node may have a conditional questionnaire where the first reviewer is asked if they want a second review.

In non-limiting embodiments of systems and methods for automatically preparing documents for an MNE, during configuration and arrangement of a workflow, a user may schedule the workflow to be repeatedly executed and, when it repeats, the filters may be automatically adjusted for changes in entity data. Further, during repeated execution, additional or fewer documents may be generated, such as additional country reports if entities have been added in any new countries, and a workflow may be automatically created or selected to have these filtered reports reviewed by stakeholders assigned to the new countries. In non-limiting embodiments, a workflow may be configured to automatically execute in response to a change in entity data, rules data, and/or the like. In an example of such a change, the workflow may be automatically altered to account for the change.

In non-limiting embodiments of systems and methods for automatically preparing documents for an MNE, after the document preparation workflow is configured by a user through the client computing device and/or another computing device in communication with the server computer, the configuration may be stored by the server computer as workflow data and/or configuration data in a configuration database in the data storage device and/or with any other stored data associated with the multi-national organization. The user may schedule repeated execution of the workflow or a portion thereof at predefined intervals and/or specified dates and/or may choose to execute the workflow once or a set number of times. In non-limiting embodiments, the server computer may execute the document preparation workflow by performing one or more actions associated with each node in the sequence of the workflow. In some examples, the server computer performs an action by issuing an instruction to at least one other system that, in response to the instruction, may perform a corresponding action. In some examples, the server computer may determine that information for performing an action is not available and/or is not specified. In such examples, the server computer may automatically generate and communicate a query for the missing information to one or more users through GUIs on other respective computing devices. The users queried may be determined based on roles that are predefined and/or specified by a user during initial configuration. As an example, information about the corporate structure of a subsidiary may be associated with a role at that subsidiary such that one or more persons are associated in a database with that role and at that subsidiary. Such determinations may also consider, for example, a geographic region associated with the action and/or subsidiary entity and identify one or more persons associated with the specified role in that region. As an example, a role may be a designated contact or agent for a country, and one or more users may be assigned to that role (and thereby assigned to the country). Roles may be stored in relation to users in the entity database of the advisor GUI 102 or in a separate roles or user database.

In non-limiting embodiments of systems and methods for automatically preparing documents for an MNE, the server computer may output structured data, a completed form, a report, a graphical chart, and/or the like. In non-limiting embodiments, the server computer 100 may output data to one or more external systems or applications, such as a planning tool, a tax filing tool, a monitoring tool, and/or the like. In non-limiting embodiments, the output data may be in the form of one or more documents, such as a completed tax form (e.g., in PDF or some other format), a partially-completed form, or a file including structured data for receipt by external systems (e.g., JavaScript Object Notation (JSON), Extensible MarkUp Language (XML), and/or the like). In examples in which structured data is output, an external system may use the data to complete a document.

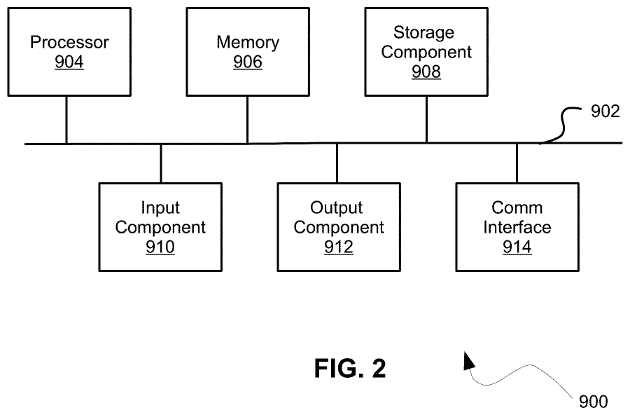

Referring now to FIG. 2, shown is a diagram of example components of a computing device 900 for implementing and performing the systems and methods described herein according to non-limiting embodiments. In some non-limiting embodiments, device 900 may include additional components, fewer components, different components, or differently arranged components than those shown in FIG. 2. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 2, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A method comprising:
providing an interactive graphical user interface to a plurality of advisor users, the interactive graphical user interface configured to facilitate each advisor user to create at least one workflow program;
receiving, from the plurality of advisor users, a plurality of workflow programs, each workflow program comprising at least a portion of an executable workflow;
receiving, from the plurality of advisor users, workflow data associated with the plurality of workflow programs, the workflow data comprising at least one element of metadata;
hosting, on a platform accessible to a plurality of client users, the plurality of workflow programs in association with the workflow data;
receiving, from a client user of the plurality of client users, a selected workflow program of the plurality of workflow programs, the selected workflow program associated with an advisor user of the plurality of advisor users;
generating a workspace environment accessible to the advisor user corresponding to the selected workflow program, the workspace environment based on the at least a portion of the executable workflow associated with the selected workflow program;
populating the workspace environment with entity data received from or identified by the client user to configure an executable workflow; and
automatically executing the executable workflow in response to at least one of the following: a user request, a scheduled time, a change in law or regulation, a change in entity data, or any combination thereof.

2. The method of claim 1, wherein the workspace environment comprises a second interactive graphical user interface configured to visualize the executable workflow and modify the executable workflow based on input received from the advisor users through the second interactive graphical user interface or received from the client user through a prompt.

3. The method of claim 1, further comprising:
determining at least one suggested workflow program based at least partially on an entity footprint associated with an entity of the client users; and
displaying the at least one suggested workflow program to the client user, the at least one suggested workflow program comprising the selected workflow program.

4. The method of claim 3, wherein the at least one suggested workflow program is determined based at least partially on a change in law or regulation.

5. The method of claim 1, further comprising:
displaying, to the client users, a search interface configured to receive at least one search parameter;
querying metadata associated with the plurality of workflow programs based on the at least one search parameter to identify at least one workflow program matching the at least one search parameter; and
displaying the at least one workflow program to the client user, the at least one workflow program comprising the selected workflow program.

6. The method of claim 1, wherein the workflow data comprises metadata including the at least one element of metadata, the metadata comprising at least one of the following: a service agreement, an identification of at least one advisor contract, a description of a workflow program, a form, a role associated with the workflow program, an individual advisor associated with the workflow program, or any combination thereof.

7. The method of claim 1, further comprising:
receiving, from the client user, input data in response to at least one of the following: a questionnaire, a form, a prompt, or any combination thereof; and
configuring the executable workflow based at least partially on the input data.

8. The method of claim 7, wherein the input data comprises the entity data.

9. The method of claim 1, wherein generating the workspace environment comprises modifying an existing workspace environment to include the selected workflow program.

10. The method of claim 1, wherein generating the workspace environment comprises generating at least one graphical user interface configured to access data in an existing workspace environment.

11. The method of claim 1, further comprising:
receiving, from the client user, a filter identifying a subset of entity data; and
retrieving the subset of entity data based on the filter.

12. The method of claim 1, further comprising:
receiving, from the advisor user, a filter identifying requested entity data;
communicating, to the client user, a data access request based on the filter; and
receiving, from the client user, an approval or denial of the data access request.

13. The method of claim 1, further comprising:
generating a dashboard graphical user interface accessible by the client user, the dashboard graphical user interface comprising an identification of an advisor and/or an advisor contract associated with the selected workflow program.

14. The method of claim 1, wherein the selected workflow program comprises at least one node configured to generate a prompt to the client user to request a review of data or a document.

15. A system comprising at least one processor programmed or configured to:
provide an interactive graphical user interface to a plurality of advisor users, the interactive graphical user interface configured to facilitate each advisor user to create at least one workflow program;
receive, from the plurality of advisor users, a plurality of workflow programs, each workflow program comprising at least a portion of an executable workflow;
receive, from the plurality of advisor users, workflow data associated with the plurality of workflow programs, the workflow data comprising at least one element of metadata;
host, on a platform accessible to a plurality of client users, the plurality of workflow programs in association with the workflow data;
receive, from a client user of the plurality of client users, a selected workflow program of the plurality of workflow programs, the selected workflow program associated with an advisor user of the plurality of advisor users;
generate a workspace environment accessible to the advisor user corresponding to the selected workflow program, the workspace environment based on the at least a portion of the executable workflow associated with the selected workflow program;
populate the workspace environment with entity data received from or identified by the client user to configure an executable workflow; and
automatically execute the executable workflow in response to at least one of the following: a user request, a scheduled time, a change in law or regulation, a change in entity data, or any combination thereof.

16. The system of claim 15, wherein the workspace environment comprises a second interactive graphical user interface configured to visualize the executable workflow and modify the executable workflow based on input received from the advisor user through the second interactive graphical user interface or received from the client user through a prompt.

17. The system of claim 15, wherein the at least one processor is further programmed or configured to:
determine at least one suggested workflow program based at least partially on an entity footprint associated with an entity of the client user; and
display the at least one suggested workflow program to the client user, the at least one suggested workflow program comprising the selected workflow program.

18. The system of claim 17, wherein the at least one suggested workflow program is determined based at least partially on a change in law or regulation.

19. The system of claim 15, wherein the at least one processor is further programmed or configured to:
display, to the client user, a search interface configured to receive at least one search parameter;
query metadata associated with the plurality of workflow programs based on the at least one search parameter to identify at least one workflow program matching the at least one search parameter; and
display the at least one workflow program to the client user, the at least one workflow program comprising the selected workflow program.

20. The system of claim 19, wherein the workflow data comprises metadata including the at least one element of metadata, the metadata comprising at least one of the following: a service agreement, an identification of at least one advisor contract, a description of a workflow program, a form, a role associated with the workflow program, an individual advisor associated with the workflow program, or any combination thereof.

21. The system of claim 15, wherein the at least one processor is further programmed or configured to:
receive, from the client user, input data in response to at least one of the following: a questionnaire, a form, a prompt, or any combination thereof; and
configure the executable workflow based at least partially on the input data.

22. The system of claim 21, wherein the input data comprises the entity data.

23. The system of claim 15, wherein generating the workspace environment comprises modifying an existing workspace environment to include the selected workflow program.

24. The system of claim 15, wherein generating the workspace environment comprises generating at least one graphical user interface configured to access data in an existing workspace environment.

25. The system of claim 15, wherein the at least one processor is further programmed or configured to:
receive, from the client user, a filter identifying a subset of entity data; and
retrieving the subset of entity data based on the filter.

26. The system of claim 15, wherein the at least one processor is further programmed or configured to:
receive, from the advisor user, a filter identifying requested entity data;
communicate, to the client user, a data access request based on the filter; and
receive, from the client user, an approval or denial of the data access request.

27. The system of claim 15, wherein the at least one processor is further programmed or configured to:
generate a dashboard graphical user interface accessible by the client user, the dashboard graphical user interface comprising an identification of an advisor and/or an advisor contract associated with the selected workflow program.

28. The system of claim 15, wherein the selected workflow program comprises at least one node configured to generate a prompt to the client user to request a review of data or a document.

29. A computer program product comprising at least one non-transitory medium including program instructions that, when executed by at least one processor, cause the at least one processor to:
provide an interactive graphical user interface to a plurality of advisor users, the interactive graphical user interface configured to facilitate each advisor user to create at least one workflow program;
receive, from the plurality of advisor users, a plurality of workflow programs, each workflow program comprising at least a portion of an executable workflow;
receive, from the plurality of advisor users, workflow data associated with the plurality of workflow programs, the workflow data comprising at least one element of metadata;
host, on a platform accessible to a plurality of client users, the plurality of workflow programs in association with the workflow data;
receive, from a client user of the plurality of client users, a selected workflow program of the plurality of workflow programs, the selected workflow program associated with an advisor user of the plurality of advisor users;
generate a workspace environment accessible to the advisor user corresponding to the selected workflow program, the workspace environment based on the at least a portion of the executable workflow associated with the selected workflow program;
populate the workspace environment with entity data received from or identified by the client user to configure an executable workflow; and
automatically execute the executable workflow in response to at least one of the following: a user request, a scheduled time, a change in law or regulation, a change in entity data, or any combination thereof.

30. The computer program product of claim 29, wherein the workspace environment comprises a second interactive graphical user interface configured to visualize the executable workflow and modify the executable workflow based on input received from the advisor user through the second interactive graphical user interface or received from the client user through a prompt.
